(19) United States
(12) Patent Application Publication
(10) Pub. No.: US 2024/0089601 A1
(43) Pub. Date: Mar. 14, 2024

(54) DETERMINING TRANSLATION SCALE IN A MULTI-CAMERA DYNAMIC CALIBRATION SYSTEM

(71) Applicant: Intel Corporation, Santa Clara, CA (US)

(72) Inventor: Avinash Kumar, Karnataka (IN)

(73) Assignee: Intel Corporation, Santa Clara, CA (US)

(21) Appl. No.: 18/507,593

(22) Filed: Nov. 13, 2023

(51) Int. Cl. H04N 23/695; G06V 10/44; G06V 10/74

(52) U.S. Cl. CPC H04N 23/695; G06V 10/44; G06V 10/761

(57) ABSTRACT

Multi-camera dynamic calibration can be performed using three or more images, each from a separate camera viewing the same 3D scene. Multi-camera translation magnitude can be determined by incorporating information from an additional image. A relative translation scale is determined for a configuration of three cameras using a ratio of translation magnitudes. The translation scale can be expanded to configurations having more than three cameras using the relative scale of the pair-wise camera translations to determine translation scales for a multi-camera set-up. If the ground-truth translation is known for a pair of cameras, then the translation magnitude can be determined for all pairs of cameras to ground-truth accuracy. Multi-camera scale estimation is divided into smaller overlapping triplet-camera scale estimation, and the translation scale determination corresponding to each image pair is applied iteratively to overlapping sets of three images. The estimates can be merged by linearly aligning overlapping sets of estimates.

### TECHNICAL FIELD

This disclosure relates generally to the calibration of a multi-camera system, and in particular to determining a translation scale in a multi-camera dynamic calibration system.

### BACKGROUND

In a multi-camera system, multi-camera dynamic calibration includes estimating intrinsic parameters for each camera and extrinsic parameters between pairs of cameras based on information from captured images. However, scene depth computed using multi-camera calibration parameters have an unknown scale factor in multi-camera calibration systems. This is evident from the fact that given two images of a scene, it cannot be deduced if the images are of a conventional real 3-dimensional (3D) world or a miniature model of the 3D world. But, many vision applications rely on accurate and consistent depth information and the inability to compute absolute translation magnitude between cameras can be a significant drawback.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a DNN system, in accordance with various embodiments.

FIG. 2A shows an example of a multi-camera system including four cameras and having a three-dimensional scene point P, in accordance with various embodiments.

FIG. 2B shows an example of a multi-camera system with translation magnitudes estimates using the essential matrix method, in accordance with various embodiments.

FIG. 3 shows an example of a calibrated multi-camera system including three cameras and having a 3D scene point P, in accordance with various embodiments.

FIG. 4 is a block diagram illustrating an example of the system flow for estimating the translation scale using three input images, in accordance with various embodiments.

FIG. 5 shows an example configuration of a three-camera system imaging a 3D point P, in accordance with various embodiments.

FIG. 6A shows translation computed with magnitude unity for one camera pair, in accordance with various embodiments.

FIG. 6B shows translation computed with magnitude unity for two camera pairs, in accordance with various embodiments.

FIG. 6C shows triangulated points for two camera pairs, in accordance with various embodiments.

FIG. 7 is a diagram illustrating an example of vector translation, in accordance with various embodiments.

FIG. 8 is a flow chart illustrating a method for calibrating multi-camera systems, in accordance with various embodiments.

FIG. 9 is a diagram illustrating an example of the grouping of images into image pairs, in accordance with various embodiments.

FIG. 10 is a diagram illustrating an example of a multi-camera system including six cameras, in accordance with various embodiments.

FIG. 11 is a block diagram of an example computing device, in accordance with various embodiments.

### DETAILED DESCRIPTION

### Overview

Multi-camera dynamic calibration includes estimating intrinsic camera parameters based on a set of captured images, where intrinsic camera parameters may include focal length, principal point, and distortion parameters of the camera. Multi-camera dynamic calibration also includes estimating the extrinsic parameters between any pair of cameras by only using information from captured images. Extrinsic parameters include relative rotation and translation between captured images. Multi-camera dynamic calibration methods iteratively optimize calibration parameters and triangulated depths from correspondences obtained from captured images while minimizing the mean pixel reprojection error of the triangulated correspondences.

In some implementations, camera intrinsic parameters can be pre-calibrated and multi-camera dynamic calibration can be performed for calibrating external parameters in systems with multiple cameras. The external parameters are unknown and depend upon how the cameras in the multi-camera system are positioned with respect to each other when the images are captured. In some examples, extrinsic calibration for a pair of camera images (e.g., a first image from a first camera and a second image from a second camera) includes first determining a 3×3 essential matrix. The 3×3 essential matrix has five degrees of freedom using multiple image feature correspondences. The 3×3 essential matrix can be decomposed to a rotation matrix and a translation vector. In some examples, since the essential matrix has 5 degrees of freedom, it can encode three degrees for rotation angles and two degrees for a unit length translation vector. The third translation variable is constrained by the unit length. Thus, using the 3×3 essential matrix, the translation direction is estimated but translation magnitude is unknown.

Translation magnitude between a pair of cameras is related to the triangulated scene depth of selected keypoint correspondences. A keypoint correspondence can be corresponding image points, such as a pixel in each captured image (each of the first and second images) representing the same portion of the scene. Translation scale is set to unity, so the sparse scene depth has an unknown scale ambiguity. Thus, dynamic multi-camera calibration systems using these methods cannot estimate ground truth translation magnitude using image features. That is, given two images of a scene, it cannot be deduced based on image features if the images are of a conventional real 3-dimensional (3D) world or a miniature model of the 3D world.

Many vision applications rely on accurate and consistent depth information, and an inability to determine the absolute translation magnitude between cameras can be a significant disadvantage. In particular, the inability to determine the absolute translation magnitude can result in inaccuracy of 3D measurements based on stereo cameras and un-realistic blurring of background objects in portrait mode images. Additionally, for any dynamic calibration optimization post-processing methods, translation magnitude may lead to incorrect starting point and lead to local minima together with longer convergence times.

Systems and methods are provided herein for estimating the multi-camera translation magnitude by incorporating information from an additional image. In particular, the systems and methods include first determining a relative translation scale for a minimal configuration of three cameras and then generalizing the translation scale to a multi-camera set-up. In the multi-camera set-up, the relative scale of the pair-wise camera translations is estimated with respect to each pair of cameras. In some examples, if the ground-truth translation is known for a pair of cameras, then the translation magnitude can be estimated for all pairs of cameras to ground-truth accuracy.

In some implementations, a method is presented for multi-camera dynamic calibration that uses three images, each from a separate camera viewing the same 3D scene. The method includes estimating the ratio of translation magnitudes (also referred as translation scale) corresponding to the second-third image pair with respect to the first-second image pair.

In some implementations, a method is presented for multi-camera dynamic calibration using more than three images and more than three cameras viewing the same 3D scene. The method includes estimating the ratio of translation magnitudes for pairs of translation vectors corresponding to four different images. Using graph-based methods, multi-camera scale estimation is divided into smaller overlapping triplet-camera scale estimation. Then, the method for using three images and estimating the ratio of translation magnitudes corresponding to each image pair is applied to iteratively to overlapping sets of three images. The estimates can be merged by linearly aligning overlapping sets of estimates. However, ground truth translation of the multi-camera setting is not provided.

In some implementations, a method is presented for multi-camera dynamic calibration for a system with three or more cameras viewing the same scene, with a known ground truth translation magnitude for at least one pair of cameras. Based on the known ground truth translation magnitude, absolute translation magnitude can be determined for all camera pairs, providing ground truth translation values for the multi-camera system.

A DL-based multi-camera calibration system can be based on a deep neural network (DNN). The training process for a DNN usually has two phases: the forward pass and the backward pass. In some examples, DNNs includes input training samples with ground-truth labels (e.g., known or verified labels). In some examples, the training data for a DL-based multi-camera calibration is unlabeled. Instead, in the forward pass, unlabeled, real-world images are input to a DL-based multi-camera calibration system, and processed using the calibration parameters of the DNN to produce two different model-generated outputs. In the backward pass, the first model-generated output is compared to the second model-generated output, and the internal calibration parameters are adjusted to minimize differences between the first and second outputs. After the DNN is trained, the DNN can be used for various tasks through inference. Inference makes use of the forward pass to produce model-generated output for unlabeled real-world data.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

Example DNN System

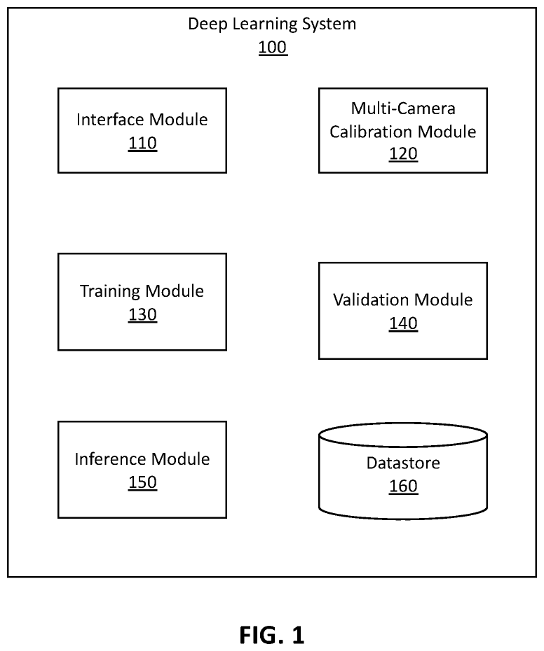

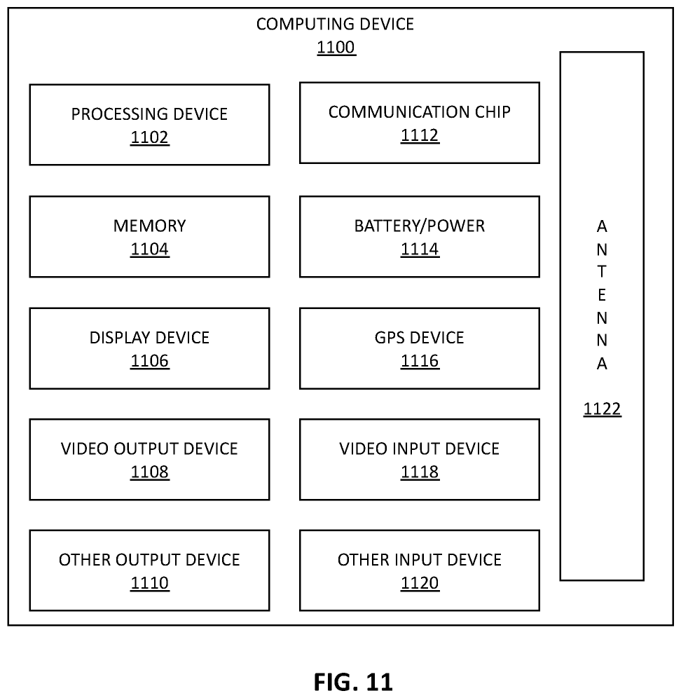

FIG. 1 is a block diagram of an example DNN system 100, in accordance with various embodiments. The DNN system 100 trains DNNs for various tasks, including multi-camera dynamic calibration of extrinsic parameters using captured images. The DNN system 100 includes an interface module 110, a multi-camera calibration module 120, a training module 130, a validation module 140, an inference module 150, and a datastore 160. In other embodiments, alternative configurations, different or additional components may be included in the DNN system 100. Further, functionality attributed to a component of the DNN system 100 may be accomplished by a different component included in the DNN system 100 or a different system. The DNN system 100 or a component of the DNN system 100 (e.g., the training module 130 or inference module 150) may include the computing device 1100 in FIG. 11.

The interface module 110 facilitates communications of the DNN system 100 with other systems. As an example, the interface module 110 supports the DNN system 100 to distribute trained DNNs to other systems, e.g., computing devices configured to apply DNNs to perform tasks. As another example, the interface module 110 establishes communications between the DNN system 100 with an external database to receive data that can be used to train DNNs or input into DNNs to perform tasks. In some embodiments, data received by the interface module 110 may have a data structure, such as a matrix. In some embodiments, data received by the interface module 110 may be an image, a series of images, and/or a video stream.

The multi-camera calibration module 120 performs multi-camera calibration of external camera parameters based on captured images. The multi-camera calibration module 120 performs calibration on real-world images. In general, the multi-camera calibration module 120 reviews the input data, identifies keypoint correspondences, and determines a relative translation scale. In some examples, the multi-camera system being calibrated includes three or more cameras, and the images from each of the cameras are divided up into image pairs for processing. Thus, for example, a captured image from a first camera and a captured image from a second camera can form a first image pair, and the captured image from the second camera and a captured image from a third camera can form a second image pair. In various examples, the images in the image pairs are captured simultaneously, or at about the same time.

To perform extrinsic calibration for a pair of images, the multi-camera calibration module 120 identifies keypoint correspondences between two images in a first image pair, where a keypoint correspondence can be corresponding image points, such as a pixel in each captured image (of the first image pair) representing the same portion of the scene. The multi-camera calibration module 120 determines a 3×3 essential matrix for the first image pair. The 3×3 essential matrix has five degrees of freedom using multiple image feature correspondences. The multi-camera calibration module 120 generates a rotation matrix and a translation vector from the 3×3 essential matrix. In some examples, since the essential matrix has 5 degrees of freedom, it can encode three degrees for rotation angles and two degrees for a unit length translation vector. The third translation variable is constrained by the unit length. Thus, using the 3×3 essential matrix, the translation direction is estimated but translation magnitude is unknown. The translation magnitude between a pair of cameras is related to the triangulated scene depth of selected keypoint correspondences. In some examples, the multi-camera calibration module 120 sets the translation scale to unity, so the sparse scene depth has an unknown scale ambiguity.

The multi-camera calibration module 120 identifies keypoint correspondences between two images in a second image pair. In various examples, one of the two images in the second image pair is one of the images in the first image pair. For instance, the captured image from the second camera can be used in the first image pair and again in the second image pair. In some examples, a different captured image from the second camera is used in the second pair. The multi-camera calibration module 120 determines a 3×3 essential matrix for the second image pair. The 3×3 essential matrix for the second image pair has five degrees of freedom using multiple image feature correspondences. The multi-camera calibration module 120 generates a rotation matrix and a translation vector from the 3×3 essential matrix for the second image pair. As described above, using the 3×3 essential matrix, the translation direction is estimated but translation magnitude is unknown. The multi-camera calibration module 120 determines the translation magnitude for the second image pair based on the translation magnitude of the first image pair. In some examples, the multi-camera calibration module 120 determines a ratio of translation magnitudes (also referred as translation scale) corresponding to the second-third image pair with respect to the first-second image pair.

In some implementations, the multi-camera calibration module 120 has a known ground truth translation magnitude for at least one pair of cameras. Based on the known ground truth translation magnitude, absolute translation magnitude can be determined for all camera pairs, providing ground truth translation values for the multi-camera system.

The training module 130 trains DNNs by using training datasets. In some embodiments, a training dataset for training a DNN may include one or more images and/or videos, each of which may be a training sample. In some examples, the training module 130 trains the multi-camera calibration module 120. The training module 130 may receive real-world image data for processing with the multi-camera calibration module 120 as described herein. In some embodiments, the training module 130 may input different data into different layers of the DNN. For every subsequent DNN layer, the input data may be less than the previous DNN layer.

In some embodiments, a part of the training dataset may be used to initially train the DNN, and the rest of the training dataset may be held back as a validation subset used by the validation module 140 to validate performance of a trained DNN. The portion of the training dataset not including the tuning subset and the validation subset may be used to train the DNN.

The training module 130 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 1, 10, 50, 100, or even larger.

The training module 130 defines the architecture of the DNN, e.g., based on some of the hyperparameters. The architecture of the DNN includes an input layer, an output layer, and a plurality of hidden layers. The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include 3 channels). A pooling layer is used to reduce the spatial volume of input image after convolution. It is used between 2 convolution layers. A fully connected layer involves weights, biases, and neurons. It connects neurons in one layer to neurons in another layer. It is used to classify images between different categories by training.

In the process of defining the architecture of the DNN, the training module 130 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 130 defines the architecture of the DNN, the training module 130 inputs a training dataset into the DNN. The training dataset includes a plurality of training samples. An example of a training dataset includes a series of images of a video stream. Unlabeled, real-world images are input to the multi-camera calibration module 120, and processed using the calibration parameters of the DNN to produce model-generated outputs. In some examples, a first model-generated output can be based on a first set of captured images from the multi-camera system and a second model-generated output can be based on a second set of captured images from the multi-camera system. In some examples, a first model-generated output can be based on a first set of keypoint correspondences in captured images from the multi-camera system and a second model-generated output can be based on a second set of keypoint correspondences in captured images from the multi-camera system. In the backward pass, the training module 130 modifies the parameters inside the DNN (“internal parameters of the DNN”) to minimize the differences between the first model-generated output is and the second model generated output and iteratively optimize calibration parameters and triangulate depths from correspondences obtained from captured images. The internal parameters include weights of filters in the convolutional layers of the DNN. In some embodiments, the training module 130 uses a cost function to minimize the differences. In some examples, the DNN performs feature detection on each of the input images, and the DNN performs pairwise feature matching between/among images in a set (e.g., the first set of captured images, the second set of captured images).

The training module 130 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 130 finishes the predetermined number of epochs, the training module 130 may stop updating the parameters in the DNN. The DNN having the updated parameters is referred to as a trained DNN.

The validation module 140 verifies accuracy of trained DNNs. In some embodiments, the validation module 140 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 140 may determine an accuracy score measuring the precision, recall, or a combination of precision and recall of the DNN. The validation module 140 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 140 may compare the accuracy score with a threshold score. In an example where the validation module 140 determines that the accuracy score of the augmented model is lower than the threshold score, the validation module 140 instructs the training module 130 to re-train the DNN. In one embodiment, the training module 130 may iteratively re-train the DNN until the occurrence of a stopping condition, such as the accuracy measurement indication that the DNN may be sufficiently accurate, or a number of training rounds having taken place.

The inference module 150 applies the trained or validated DNN to perform tasks. The inference module 150 may run inference processes of a trained or validated DNN. In some examples, inference makes use of the forward pass to produce model-generated output for unlabeled real-world data. For instance, the inference module 150 may input real-world data into the DNN and receive an output of the DNN. The output of the DNN may provide a solution to the task for which the DNN is trained for.

The inference module 150 may aggregate the outputs of the DNN to generate a final result of the inference process. In some embodiments, the inference module 150 may distribute the DNN to other systems, e.g., computing devices in communication with the DNN system 100, for the other systems to apply the DNN to perform the tasks. The distribution of the DNN may be done through the interface module 110. In some embodiments, the DNN system 100 may be implemented in a server, such as a cloud server, an edge service, and so on. The computing devices may be connected to the DNN system 100 through a network. Examples of the computing devices include edge devices.

The datastore 160 stores data received, generated, used, or otherwise associated with the DNN system 100. For example, the datastore 160 stores video processed by the multi-camera calibration module 120 or used by the training module 130, validation module 140, and the inference module 150. The datastore 160 may also store other data generated by the training module 130 and validation module 140, such as the hyperparameters for training DNNs, internal parameters of trained DNNs (e.g., values of tunable parameters of activation functions, such as Fractional Adaptive Linear Units (FALUs)), etc. In the embodiment of FIG. 1, the datastore 160 is a component of the DNN system 100. In other embodiments, the datastore 160 may be external to the DNN system 100 and communicate with the DNN system 100 through a network.

Example Multi-Camera System

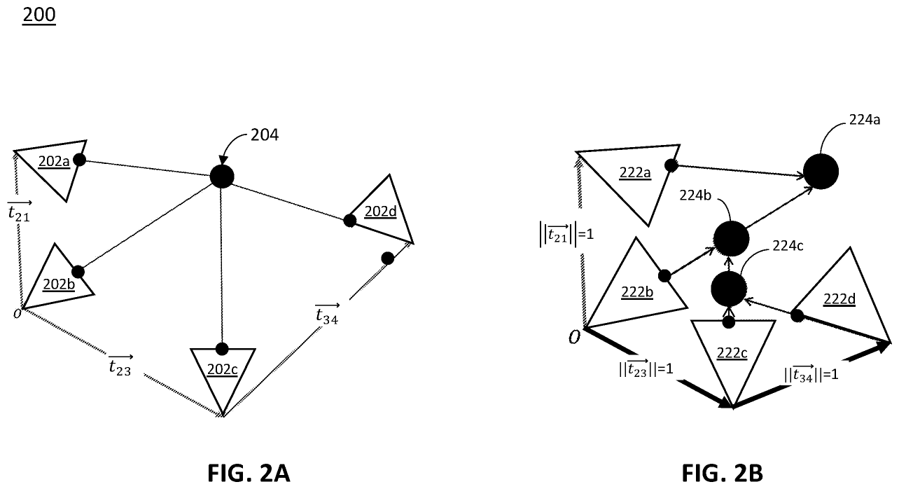

FIG. 2A shows an example of a multi-camera system including four cameras 202a-202d and having a three-dimensional scene point P 204. Each of the cameras 202a-202d captures images including the 3D scene point P 204. FIG. 2A shows the ground truth calibration, with the vector \vec{t₂₁} between the first camera 202a and the second camera 202b being a global reference edge.

FIG. 2B shows an example of a multi-camera system with translation magnitudes estimates using the essential matrix method. In particular, using the essential matrix method, the magnitude of the vector between each pair of cameras has a norm of one. Thus, the magnitude of the vector ∥\vec{t₂₁}∥ between the first camera 222a and the second camera 222b is 1, the magnitude of the vector ∥\vec{t₂₃}∥ between the second camera 222b and the third camera 222c is 1, and the magnitude of the vector ∥\vec{t₃₄}∥ between the third camera 222c and the fourth camera 222d is 1. Thus, as shown in FIG. 2B, the triangulated points P₁₂ 204a, P₂₃ 204b, and P₃₄ 204c do not coincide when the cameras are calibrated using the essential matrix method.

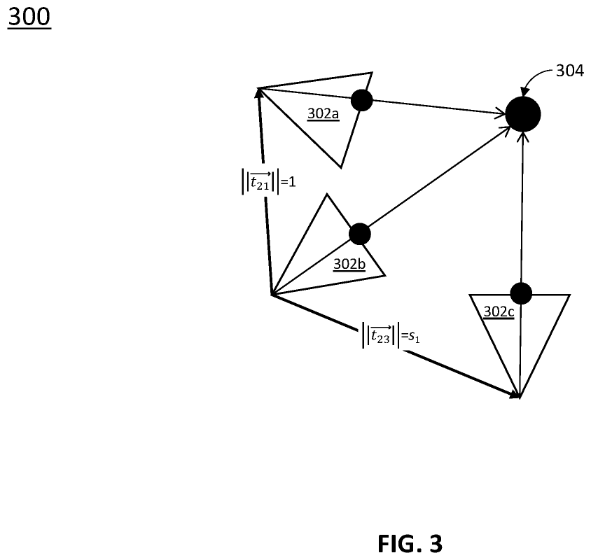

FIG. 3 shows an example of a calibrated multi-camera system including three cameras 302a-302c and having a 3D scene point P 304, in accordance with various embodiments. In particular, as described herein, the magnitude of a first vector between one pair of cameras is set to unity while the magnitude of a second vector between the other pair of cameras is based on the magnitude of the first vector. As shown in FIG. 3, the magnitude of the vector ∥t̅₂̅₁̅∥ between the first camera 302a and the second camera 302b is set to 1, and the magnitude of the vector t23 between the second camera 302b and the third camera 302c is a relative translation scale s₁. Systems and methods for determining the translation scale s₁ are described herein.

Example Multi-Camera System Calibration

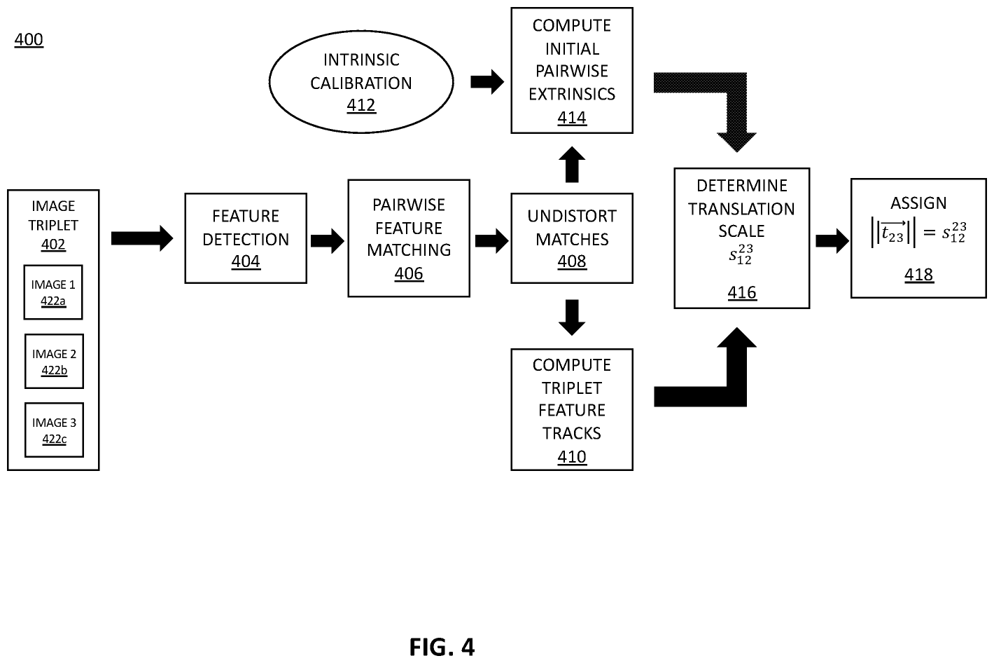

FIG. 4 is a block diagram 400 illustrating an example of the system flow for estimating the translation scale using three input images, in accordance with various embodiments. At block 402, three images (a first image 422a, a second image 422b, and a third image 422c) are input into the multi-camera calibration system. Each of the images 422a, 422b, 422c is captured from a different camera, and each camera captures a common 3D scene space from a unique position. In some examples, the three cameras used to capture each of the three images 422a, 422b, 422c form part of a larger array of cameras. In some examples, the intrinsic parameters of the cameras are known a priori based on known target-based calibration methods (such as checkerboard calibration). In some examples, each of the three images 422a, 422b, 422c can be normalized to a focal length of one. In various examples, the image formation process using each camera is defined as:

p_{ud}=Kᵢ[Rᵢ*P+\vec{tₗ}] (1)

p_{d}=f(p_{ud},dᵢ) (2)

where P=(X, Y, Z) is an unknown 3D point in a pre-defined world coordinate system, p_{ud} is the ideal undistorted perspective projection of P onto the image plane, Kᵢ is the known intrinsic matrix for camera i as shown below:

$${K}_{i} = [ \begin{matrix}{f}_{x} & 0 & u \\ 0 & {f}_{y} & v \\ 0 & 0 & 1\end{matrix} ] \qquad ( 3 )$$

where (fₓ, f_{y})=focal length, and (u, v)=center point, [Rᵢ,\vec{tₗ}] are the unknown 3×3 rotation and 3×1 translation of camera i in the world coordinate system, dᵢ are the known distortion parameters following a known distortion model (e.g., the Brown-Conrady model, which corrects for radial distortion and for tangential distortion, or the rational model), p_{d}=(x, y) is the final observed projection of P in image i after image distortion dᵢ is applied, via f, to ideal undistorted point p_{ud}.

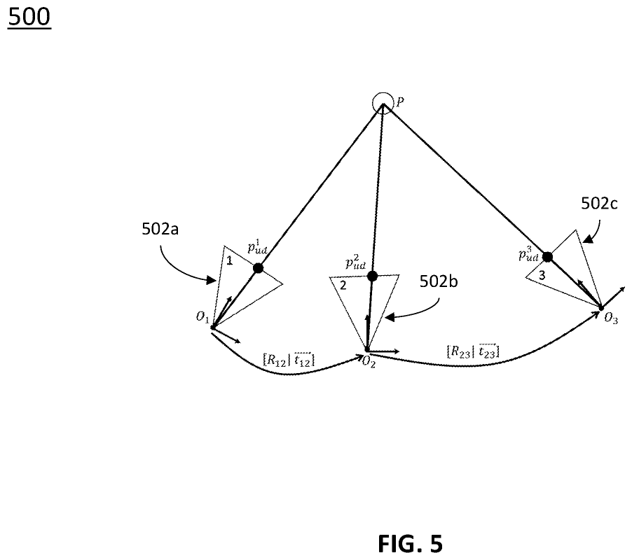

Referring ahead, FIG. 5 shows an example configuration of a three-camera system imaging a 3D point P, in accordance with various embodiments. FIG. 5 shows an example of a geometric configuration of a triplet camera capture setup including a first camera 502a, a second camera 502b, and a third camera 502c. The 3D point P is imaged to the undistorted image coordinate p_{ud}¹ in the first camera 502a, the 3D point P is imaged to the undistorted image coordinate p_{ud}² in the second camera 502b, and the 3D point P is imaged to the undistorted image coordinate p_{ud}³ in the third camera 502c. The intrinsic parameters of the cameras are known and relative rotation and translation between the cameras is unknown. In particular, the relative rotation R₁₂ between the first camera 502a and the second camera 502b is unknown, and the relative translation \vec{t₁₂} between the first camera 502a and the second camera 502b is unknown. Similarly, the relative rotation R₂₃ between the second camera 502b and the third camera 502c is unknown, and the relative translation \vec{t₂₃} between the second camera 502b and the third camera 502c is unknown. In various examples, when referring to the rotations (R₁₂, R₂₃) and translations (\vec{t₁₂}, \vec{t₂₃}), the first subscript denotes the reference camera coordinate system and the second is the target camera coordinate system. So, for R₁₂, the rotation is of the coordinate system of the first camera 502a (O₁) to the second camera 502b coordinate system located at (O₂).

Referring back to FIG. 4, the input images from block 402 are received at a feature detection module 404. At the feature detection module 404, various features of the images are detected. A feature can be a piece of information about the content of an image, such as whether a selected region of the image has selected properties. Features may be specific structures in the image such as points, edges, or objects. In various examples, a feature can be any selected part of an image, and it can be a portion of an image that is notably different and/or distinct from other portions of the image. In some examples, a feature is used in machine learning model, such as the DNN described above with respect to FIG. 1, and a feature is an individual measurable property or characteristic of an image. A feature can be numerical or categorical. Numerical features are continuous values that can be measured on a scale (e.g., pixel color, pixel brightness, etc.). Categorical features are discrete values that can be grouped into categories. In some examples, the feature detection module 404 includes a multi-scale 2D feature detection and description algorithm that detects feature points in each image and generates feature descriptors of detected feature points. In some examples, the feature detection module can operate in nonlinear scale spaces.

At block 406, pairwise feature matching is performed at a pairwise feature matching module. At block 406, the three images 422a, 422b, 422c from the image triplet at block 402 are grouped into two sets of pairwise images (with each pair having one image in common). For example, the images can be grouped into a first image pair including the first image 422a and the second image 422b and a second image pair including the second image 422b and the third image 422c, such that each image pair has the second image 422b in common. For each of the first and second pairs of images, the detected features from the feature detection module 404 are matched to generate feature correspondences.

The pairwise feature matching process at block 406 may follow multiple steps for feature matching. The feature matching steps can include a nearest neighbor search, such as a 2-nearest neighbor search which identifies the top two nearest neighbors to the query. The feature matching steps can include a ratio test, in which each keypoint of a first image in an image pair is matched with a number of keypoints from a second image in an image pair, and the best matches for each keypoint are kept, where the best matches are the matches with the smallest distance measurement. In some examples, two best matches are kept for each keypoint. The ratio test can check that the distances between the two best matches are sufficiently different, and, if the distances between the two best matches are not sufficiently different, then, based on the ratio test, the keypoint is eliminated and may not be used for further calculations.

The feature matching steps can include a symmetry test where the roles of the first and the second images are reversed. In particular, the 2-nearest neighbor search and ratio test are applied in the reverse direction for finding best keypoint matches from the second image to the first image. The set of backward matches (i.e., matches from the second image to the first image) are compared to the set of earlier computed forward matches (i.e., matches from the first image to the second image), and the common matching pairs are selected as candidate feature matches. In general, when, for a keypoint in the first image, a selected keypoint in the second image is selected as its best match, then for that same selected keypoint in the second image, the corresponding keypoint in the first image is selected as its best match. Thus, the symmetry test identifies keypoint matches that are selected in both a forward keypoint match step and in a backward match step. As described above, a forward keypoint match is a keypoint match in which a keypoint from the first image is selected and the corresponding keypoint in the second image is identified, and a backward keypoint match is a keypoint match in which a keypoint from the second image is selected and the corresponding keypoint in the first image is identified. In some examples, a forward keypoint match step is performed first, and, for a selected keypoint in the first image, the identified corresponding keypoint in the second image is selected. Then, the identified corresponding keypoint in the second image is the selected keypoint in the second image for the backward match step. Thus, it can be determined whether the identified corresponding keypoint in the second image is matched with the selected keypoint in the first image by comparing the backward match with the forward match.

The feature matching steps can also include fundamental matrix-based outlier removal of incorrect matches. The pairwise feature matching module 406 outputs a set of feature correspondences between each of the images of the first image pair and each of the images of the second image pair. In various examples, pixels from each image in a pair of images are matched or paired together as being keypoint correspondences between the two images of the pair.

At block 408, the matches from the pairwise feature matching block 406 are undistorted. In particular, given known intrinsic parameters for each camera (i.e., parameters (K₁, d₁) for the first camera, parameters (K₂, d₂) for the second camera, and parameters (K₃, d₃) for the third camera), the matches can be undistorted. In some examples, since d 1 are the known distortion parameters following a known distortion model as described above, the undistort module undistorts matches based on the distortion model used (e.g., fisheye, the Brown-Conrady model, the rational model). The undistort module 408 can use a backward undistortion model f⁻¹ (see Equation (2) above) to undistort the matches. The matched distorted point p d (described above) is then used to compute the undistorted point p_{ud} (described above) using the backward undistortion model f⁻¹.

At block 410, triplet feature tracks are computed. In particular, the correspondences between image pairs that have a common keypoint in the common image are accumulated to obtain keypoint correspondences that span all three images 422a, 422b, 422c. Here, the second image 422b is the common image between the first image pair and the second image pair. Thus, keypoints from the second image 422b that have correspondences in both the first image pair and the second image pair are accumulated. These keypoints can be referred to as triplet tracks.

At block 414, initial pairwise extrinsic parameters are computed. Intrinsic camera calibration parameters 412 are input to the extrinsic parameter computation block 414. At block 414, the undistorted keypoint correspondences p_{ud} from block 408 for each image pair are used to estimate the pose (rotation and translation) of one camera with respect another camera using the 5-point method. For example, undistorted keypoint correspondences for the first image pair (the first image 422a and the second image 422b) are used to estimate the pose of the first camera with respect to the second camera. Similarly, undistorted keypoint correspondences for the second image pair (the second image 422b and the third image 422c) are used to estimate the pose of the second camera with respect to the third camera. Thus, at block 414, pairwise extrinsics are calculated for the first image pair, and thus for the first and second camera, including [R₁₂, \vec{t₁₂}]. Similarly, at block 414, pairwise extrinsics are calculated for the second image pair, and thus for the second and third camera, including [R₂₃, \vec{t₂₃}].

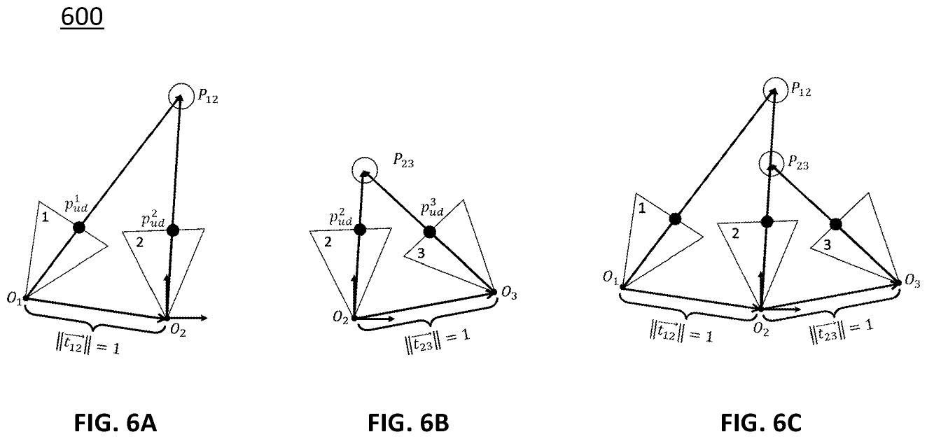

According to various examples, the 5-point method is a stable method for determining camera poses. The 5-point method uses five image correspondences (e.g., five keypoint correspondences) between images in a pair of images to find the pose. This method is run iteratively in a random sample consensus (RANSAC) framework to find a best pose estimate. Each of the five correspondences provide five constraints between the images leading to the estimation of three variables of rotation and two variables of translation (tₓ, t_{y}). The translation magnitude ∥\vec{t}∥ is set to 1, thereby yielding automatic computation of t_{z}=√(1−tₓ²−t_{y}²). Note that the sign ambiguity of t_{z} can be automatically resolved using chirality constraints in the 5-point method. The resulting geometric configuration of the first camera pair with unit translation is shown in FIG. 6A. The resulting geometric configuration of the second camera pair with unit translation is shown in FIG. 6B.

In particular, FIG. 6A shows translation computed with magnitude unity for the left camera pair (the first camera and the second camera), in accordance with various embodiments. The relative camera rotations match the ground truth configuration shown in FIG. 5. Similarly, FIG. 6B shows translation computed with magnitude unity for both the right camera pair (the second camera and the third camera), in accordance with various embodiments, and the relative camera rotations match the ground truth configuration shown in FIG. 5.

However, as shown in FIG. 6C, when merged, the triangulated points for the two camera configurations are not equal. In particular, on triangulating a single triplet track (p_{ud}¹,p_{ud}²,p_{ud}³), each of the two camera pairs triangulate to two separate points, with the first camera pair (p_{ud}¹, p_{ud}²) triangulating to P₁₂ and the second camera pair (p_{ud}²,p_{ud}³) triangulating to P₂₃. As shown in FIG. 6C, however, P₁₂≠P₂₃. Ideally, the points P₁₂ and P₂₃ should correspond to the same 3D point P as shown in FIG. 5. However, because the translation magnitude is between the cameras of each image pair is set to unit magnitude, the points do not correspond.

Referring back to FIG. 4, the output from the blocks 410 and 414 are input to block 416, where a translation scale is determined to change the extrinsic parameters such that the triangulated points (e.g., P₁₂ and P₂₃) are equal and map to the same point. In particular, a translation scale s₁₂²³ to correct for the triangulated scene depth inequality (i.e., the difference between P₁₂ and P₂₃) can be determined. Using the translation scale, the translation vector for the second pair of images (i.e., the second and third cameras) can be scaled by a factor of s₁₂²³, to find the translation magnitude at block 418, with the result that P₁₂=P₂₃.

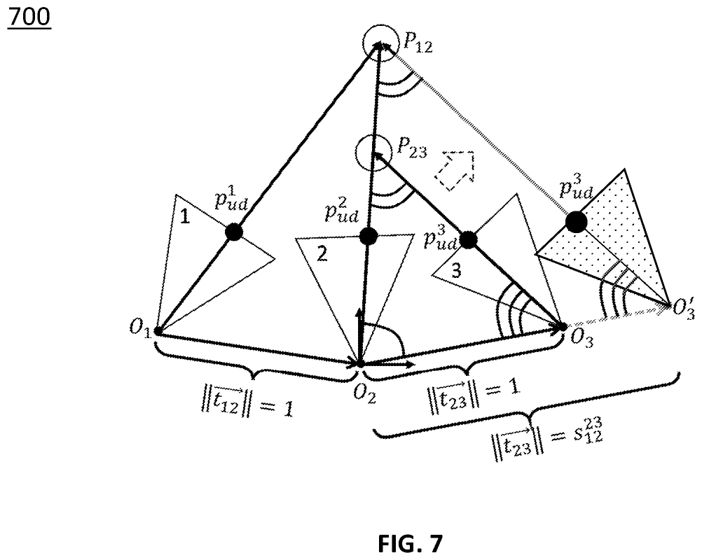

FIG. 7 is a diagram illustrating an example of vector translation, in accordance with various embodiments. In particular, as shown in FIG. 7, the translation vector for the third camera is translated along the translation vector \vec{O₂O₃}, resulting in the translated location of the third camera being centered at O₃′ with \vec{O₂O₃′}=s₁₂²³*\vec{t₂₃}. This results in the back-projected image ray

$$\vec{{O}_{3} {p}_{ud}^{3}}$$

moving parallel to itself to the new vector

$$\vec{{O}_{3}^{′} {p}_{ud}^{3}}$$

as shown in FIG. 7. Thus, the 5-point triangulated scene point P₂₃ at the intersection of rays

$$\vec{{O}_{2} {p}_{ud}^{2}}$$

and

$$\vec{{O}_{3} {p}_{ud}^{3}}$$

moves to the location P₁₂ which is also the intersection of back-projected rays

$$\vec{{O}_{2} {p}_{ud}^{2}}$$

and

$$\vec{{O}_{3} {p}_{ud}^{3}} .$$

Using similar triangulation on ΔP₂₃O₂O₃ and ΔP₁₂O₂O₃′ results in:

$$\frac{‖ {O}_{2} {O}_{3} ‖}{‖ {O}_{2} {P}_{23} ‖} = \frac{‖ {O}_{2} {O}_{3}^{′} ‖}{‖ {O}_{2} {P}_{12} ‖}$$

Additionally, the relative translation scale s₁₂²³ between the first and second cameras and between the second and third cameras can be determined as follows:

$$\frac{‖ \vec{{t}_{23}} ‖}{‖ \vec{{P}_{23}} ‖} = \frac{{s}_{12}^{23} * ‖ \vec{{t}_{23}} ‖}{‖ \vec{{P}_{12}} ‖}$$

$${s}_{12}^{23} = \frac{‖ \vec{{P}_{12}} ‖}{‖ \vec{{P}_{23}} ‖} ∵ ‖ \vec{{t}_{23}} ‖ = 1$$

where ∥\vec{P₁₂}∥ and ∥\vec{P₂₃}∥ are the magnitude of the depth of the 3D point computed in the O₂ coordinate system for the second camera.

According to various implementations, for any set of three cameras, there are multiple possible correspondences, with each correspondence triangulating to a different 3D scene point. Each of the multiple possible correspondences can be a different estimate of s₁₂²³. In various examples, the mean value of each estimate s₁₂²³ is determined after removing outliers using the interquartile range method. Thus, the relative translation scale can be determined as the ratio of the magnitude of the scene depth triangulated using the extrinsic parameters estimated by the 5-point method as described herein.

For a dynamic calibration system, an optimization step can be the last step of non-linearly refining the initial calibration parameters. Here, the initial set of calibration parameters are the relative rotation and translation vectors between each pair of the set of three cameras. While the rotation is initialized by the 5-point method as described above, the translation can be initialized as default by the 5-point method using magnitude unity, or the translation can be initialized using the scaling method described above. In some examples, the translation magnitude for a first pair of cameras can be set to unity, and the translation magnitude for the second pair of cameras can be scaled as described above. In various examples, initializing relative translation scale as ∥\vec{t}∥=s₁₂²³ using the methods and systems described herein performs six times faster than initializing with fixed scale magnitude of one or ∥\vec{t}∥=1. Similarly, in various examples, initializing relative translation scale as ∥\vec{t}∥=s₁₂²³ using the methods and systems described herein has a reprojection error that is more than three time less than the reprojection error when initializing with fixed scale magnitude of one or ∥\vec{t}∥=1.

Example Method for Multi-Camera System Calibration

According to various implementations, the method described above with respect to FIGS. 3-7 can be extended to multi-camera systems with more than three cameras. When extending to the multi-camera calibration method to more than three cameras, the relative translation scale between any two pairs of cameras can be determined without having the same camera be the common camera among all camera pairs.

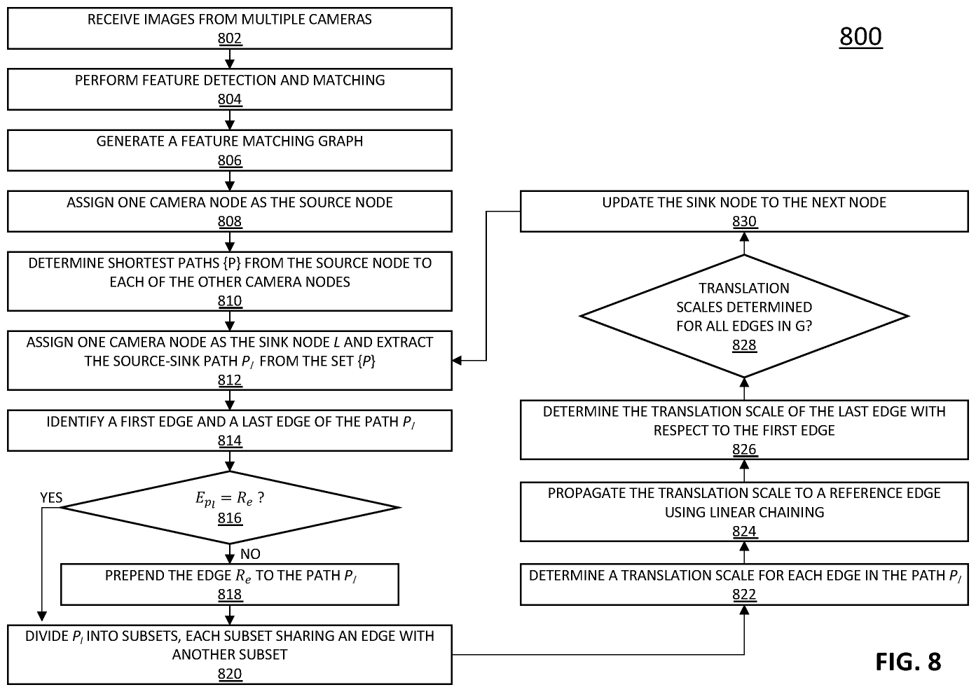

FIG. 8 is a flow chart illustrating a method 800 for calibrating multi-camera systems, in accordance with various embodiments. At step 802, images are received from multiple cameras. The images can be from multiple cameras capturing the same scene. In various examples, each of the cameras in the multi-camera system captures the scene from a different position and thus captures a different view of the scene. The images from each of the cameras can overlap, and, in particular, images from adjacent cameras include overlapping subject matter.

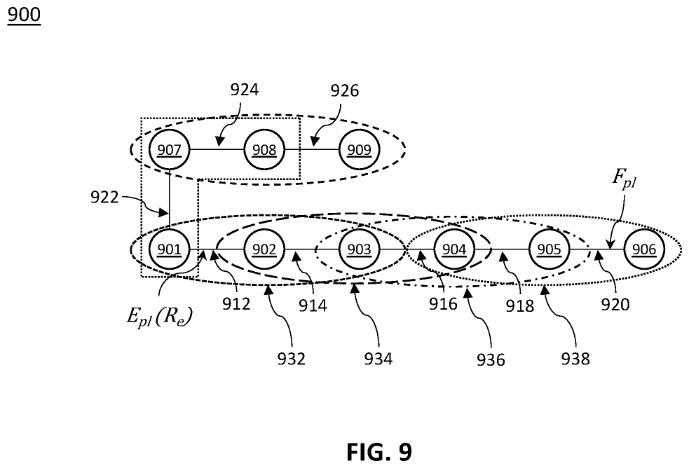

At step 804, feature detection is performed on the images, and features in each of the images are detected. The images are grouped in image pairs with each image pair including at least one image that is also an image in another image pair. Additionally, image pairs include images from adjacent cameras. FIG. 9 is a diagram illustrating an example of the grouping of images into image pairs, in accordance with various embodiments. The grouping of images into image pairs is described in greater detail below. Pairwise feature matching is performed on each image pair. As discussed above, for every image pair ij with mᵢⱼ pairwise matches, the value

$${w}_{ij} = \frac{1}{{m}_{ij}}$$

is determined.

At step 806, a feature matching graph is generated. In some examples, the feature matching graph is a fully connected undirected image matching graph G with the images as nodes and edge weights wᵢⱼ between camera nodes i and j.

At step 808, one camera node is assigned as the source node Nₛ of the feature matching graph G. In some examples, the camera node assigned as the source node is the reference node of the multi-camera system, and the reference node has the world coordinate system.

At step 810, the shortest path from the source node Nₛ to each of the other nodes N, of the feature matching graph G is determined. In some examples, the shortest path is determined using Dijkstra's algorithm. Thus, for every node Nᵢ, there is a path from Nₛ to Nᵢ. In some examples, the set of shortest paths is denoted as {P}.

At step 812, another camera node can be assigned as the sink node L of the feature matching graph G. In some examples, the camera node assigned as the sink node L can be randomly selected. Next, the path Pₗ from the source node to the sink node L is extracted from the set of paths {P}. Note that the path Pₗ is a sequence of edges connecting image nodes. Referring to FIG. 9, if node 906 is assigned as the sink node (i.e., L=6), the path Pₗ is the path from the source node 901 to the sink node 906, having edges 912, 914, 916, 918, 920.

At step 814, the first edge in the set of the path Pₗ is identified and denoted Eₚ_{ₗ} and the last edge in the set of the path Pₗ is identified and denoted Fₚ_{ₗ}. For example, in FIG. 9, Eₚ_{ₗ} is the edge 912 between the first node 901 and the second node 902 and Fₚ_{ₗ} is the edge 920 between the fifth node 905 and the sixth node 906. Additionally, a global reference edge Rₑ is assigned. In some examples, the global reference edge is an edge for which a distance is known. In other examples, the global reference edge length is set to a selected length. In some examples, the global reference edge length is set to unity. In some examples, with reference to FIG. 9, the edge Eₚ_{ₗ}, the edge 912 between the first node 901 and the second node 902, is set as the global reference edge.

Once the global reference edge Rₑ is set, at step 816, determine whether, for any of the nodes, when the node is assigned as the sink node, the shortest path to the source node doesn't include the global reference edge. That is, determine whether, for the shortest path between the assigned sink node and the source node, the first edge Eₚ_{ₗ} is also the global reference edge Rₑ. If Eₚ_{ₗ}≠Rₑ, then pre-pend the path by edge Rₑ. For example, in FIG. 9, if the sink node is set to L=9 (the ninth node 909), then Pₗ includes the edge 922 between the first node 901 and the seventh node 907, the edge 924 between the seventh node 907 and the eighth node 908, and the edge 926 between the eighth node 908 and the ninth node 909. However, if the sink node is set to L=9 (the ninth node 909) and Eₚ_{ₗ} equals the edge 922, which is not equal to Rₑ, since Rₑ is set to the first edge 912 between the first node 901 and the second node 902. Thus, Pₗ is pre-pended by Rₑ to get updated path Pₗ including the edges 912, 922, 924, and 926.

Note that since the path Pₗ is the shortest path connecting two nodes, it has no branches. Thus, the adjacency matrix representation of this path is diagonal (i.e., if A is the square adjacency matrix, then A(r, r+1)=1, with all other entries 0). At step 820, the path Pₗ can be divided into consecutive smaller sub-paths of edge length two, with an overlap of one edge. For example, in FIG. 9, the two edge sub-paths are circled as sets of three nodes, with each set of three nodes sharing an edge with another set of three nodes. As shown in FIG. 9, the path Pₗ includes four sets of three nodes: (pₗ∈[{node 901→node 902→node 903}, {node 902→node 903→node 904}, {node 903→node 904→node 905}, {node 904→node 905→node 906}]). The first set 932 {node 901→node 902→node 903} shares the edge 914 with the second set 934 {node 902→node 903→node 904}, the second set 934 {node 902→node 903→node 904} shares the edge 916 with the third set 936 {node 903→node 904→node 905}, and the third set 936 {node 903→node 904→node 905} shares the edge 918 with the fourth set 938 {node 904→node 905→node 906}. Thus, for each sub-path in pₗ, there are three nodes and two edges. The three nodes correspond to camera images, and the edges correspond to a translation vector between the images. Thus, the triplet scale estimation method described above can be applied to determine a relative translation scale sₚ_{ₗ} for each image triplet in pₗ. In FIG. 9, the scale values s₁₂²³, s₂₃³⁴, s₃₄⁴⁵, s₄₅⁵⁶ can be determined as described above.

At step 822, the translation scale for each edge in the path Pₗ is determined. At step 824, the translation scale is propagated to the reference edge using linear chaining. In particular, because there is an edge overlap in the sets of three nodes, the estimated translation scales can be linearly composed to obtain the translation scale between any two pairs of images as s=sₚ_{₀}*sₚ_{₁}*. Thus, the translation scale between the last edge Fₚ_{ₗ} and first edge Eₚ_{ₗ} of path Pₗ can be determined. In the example shown in FIG. 9, the scale between edges 912 and 920 can be determined as follows:

s₁₂⁵⁶=s₄₅⁵⁶*s₃₄⁴⁵*s₂₃³⁴*s₁₂²³

Thus, the translation scale of the last edge Fₚ_{ₗ} (here, edge 920 with respect to the global reference edge can be determined due to the single edge overlap in the sets of three nodes.

At step 826, the translation scale of the last edge of the path Pₗ with respect to the first edge of the path Pₗ is determined. In some examples, s is denoted as the translation scale between the last edge and the first edge of Pₗ and the value of s is stored. The path Pₗ contains other intermediate nodes as well whose shortest path are already part of Pₗ since growing a shortest path by the least possible edge weight results in shortest path including that edge. Since the path Pₗ contains other intermediate nodes, the determination of s can be used to get the translation scale for all the edges in the path Pₗ with respect to the first edge Eₚ_{ₗ}. The translation scale for each edge in the path Pₗ is determined and stored. The node Nᵢ is added to the set of visited nodes {V}.

At step 828, it is determined whether the translation scales with respect to the global reference edge Rₑ have been determined for each of the edges in the paths of the set {P}. If the translation scales for each of the edges have been determined, the method 800 ends. If there are additional translation scales to determine, the method 800 proceeds to step 830.

At step 830, another node from the image matching graph G (from step 806 above) is selected as the sink node Nⱼ∈G≠{V}. The method returns to step 812, with the node Nⱼ assigned as the sink node.

In some examples, additional information about the multi-camera system is available and can be leveraged in calibrating the system. For example, a fixed subset of cameras in the multi-camera array can be pre-calibrated using a target-based calibration method. In some examples, when the larger multi-camera systems are built from smaller modules of camera systems, the smaller modules of camera systems can be pre-calibrated. In one example, a multi-camera system includes one or more Time of Flight (ToF) sensors. Each ToF sensor may be individually fully calibrated, but when put together in the multi-camera system, the relative pose (rotation and translation) of the ToF sensors may need to be re-determined.

Thus, according to various implementations, the extrinsic parameters of rotation and translation can be already known fora small set of cameras. In order to determine the translation scale for camera pairs for which the extrinsic parameters are not known, the global reference edge Rₑ (discussed above with respect to FIG. 8) can be set to one of the camera pairs for which the extrinsic parameters are known a-priori. In some examples, one of the nodes of edge Rₑ is assigned as the source node and the method 800 can be applied.

Referring back to FIG. 7, for a group of three cameras, the global reference edge Rₑ can correspond to the translation vector between the first and second cameras. As described above, the direction \vec{t₁₂} of can be determined, and the magnitude of \vec{t₁₂} (that is, ∥\vec{t₁₂}∥) can be fixed to the pre-calibrated value (e.g., k). The relative translation scale s₁₂²³ can be determined as described above, and thus the translation magnitude of the neighboring camera pair (the second camera and the third camera) can be determined as ∥\vec{t₂₃}∥=k*s₁₂²³. The translation scale can be propagated forward for next camera pair. For example, the translation scale for the third and fourth camera pair can be determined as ∥\vec{t₃₄}∥=∥\vec{t₂₃}∥*s₂₃³⁴, etc. In various implementations, using the known translation scale, rotation and translation estimates for each of the cameras can be adjusted.

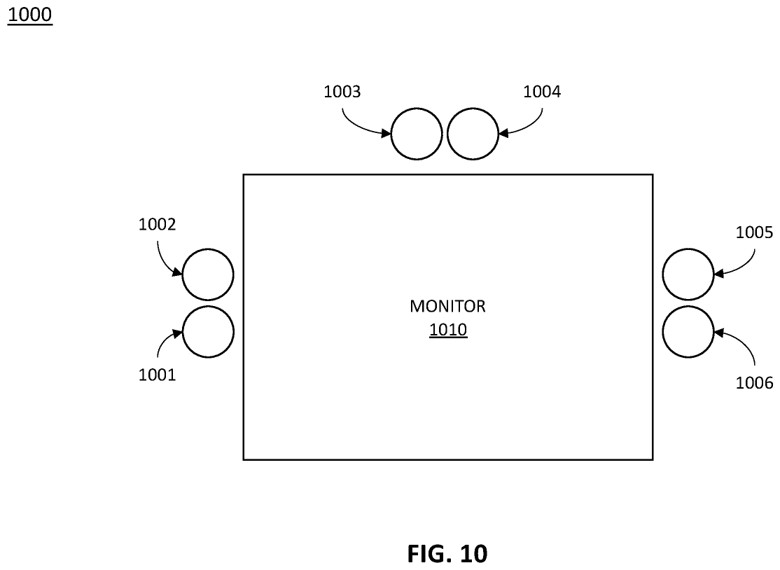

FIG. 10 is a diagram illustrating an example of a multi-camera system 1000 including six cameras, in accordance with various embodiments. In some examples, each of the cameras 1001, 1002, 1003, 1004, 1005, 1006 is part of a camera pair ({1001, 10021, 11003, 1004}, {1005, 1006}), and each of the camera pairs is already calibrated for both intrinsic and extrinsic parameters. Thus, for example, the translation magnitude and direction for the translation \vec{t₁₂} between the first camera 1001 and second camera 1002 are known, the translation magnitude and direction for the translation \vec{t₃₄} between the third camera 1003 and fourth camera 1004 are known, and the translation magnitude and direction for the translation \vec{t₅₆} between the fifth camera 1005 and sixth camera 1006 are known.

In one example, the cameras 1001, 1002, 1003, 1004, 1005, 1006 are arranged around the perimeter of a monitor 1010, facing a user of the monitor. In various implementations, an initial ground truth translation estimate between the three pairs of cameras ({1001, 10021, 11003, 10041, 11005, 1006}) can be determined. In some examples, each camera pair is a stereo camera. The cameras 1001, 1002, 1003, 1004, 1005, 1006 of the three camera pairs can be split into two groups of three cameras, and the calibration systems and methods described herein can be used on each group of three cameras to determine translation magnitudes for the multi-camera system. For instance, a first subset of cameras can include the first camera 1001, the second camera 1002, and the third camera 1003, and the second subset of cameras can include the fourth camera 1004, the fifth camera 1005, and the sixth camera 1006. Using the calibration systems and methods described herein, the relative translation between the second 1002 and third 1003 cameras (\vec{t₂₃}) and the relative translation between the fourth 1004 and the fifth 1005 cameras (\vec{t₄₅}) can be determined.

Example Computing Device

FIG. 11 is a block diagram of an example computing device 1100, in accordance with various embodiments. In some embodiments, the computing device 1100 may be used for at least part of the deep learning system 100 in FIG. 1. A number of components are illustrated in FIG. 11 as included in the computing device 1100, but any one or more of these components may be omitted or duplicated, as suitable for the application. In some embodiments, some or all of the components included in the computing device 1100 may be attached to one or more motherboards. In some embodiments, some or all of these components are fabricated onto a single system on a chip (SoC) die. Additionally, in various embodiments, the computing device 1100 may not include one or more of the components illustrated in FIG. 11, but the computing device 1100 may include interface circuitry for coupling to the one or more components. For example, the computing device 1100 may not include a display device 1106, but may include display device interface circuitry (e.g., a connector and driver circuitry) to which a display device 1106 may be coupled. In another set of examples, the computing device 1100 may not include a video input device 1118 or a video output device 1108, but may include video input or output device interface circuitry (e.g., connectors and supporting circuitry) to which a video input device 1118 or video output device 1108 may be coupled.

The computing device 1100 may include a processing device 1102 (e.g., one or more processing devices). The processing device 1102 processes electronic data from registers and/or memory to transform that electronic data into other electronic data that may be stored in registers and/or memory. The computing device 1100 may include a memory 1104, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1104 may include memory that shares a die with the processing device 1102. In some embodiments, the memory 1104 includes one or more non-transitory computer-readable media storing instructions executable for occupancy mapping or collision detection, e.g., the method 900 described above in conjunction with FIG. 9 or some operations performed by the DNN system 100 in FIG. 1. The instructions stored in the one or more non-transitory computer-readable media may be executed by the processing device 1102.

In some embodiments, the computing device 1100 may include a communication chip 1112 (e.g., one or more communication chips). For example, the communication chip 1112 may be configured for managing wireless communications for the transfer of data to and from the computing device 1100. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1112 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1112 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1112 may operate in accordance with other wireless protocols in other embodiments. The computing device 1100 may include an antenna 1122 to facilitate wireless communications and/or to receive other wireless communications (such as AM or FM radio transmissions).

In some embodiments, the communication chip 1112 may manage wired communications, such as electrical, optical, or any other suitable communication protocols (e.g., the Ethernet). As noted above, the communication chip 1112 may include multiple communication chips. For instance, a first communication chip 1112 may be dedicated to shorter-range wireless communications such as Wi-Fi or Bluetooth, and a second communication chip 1112 may be dedicated to longer-range wireless communications such as global positioning system (GPS), EDGE, GPRS, CDMA, WiMAX, LTE, EV-DO, or others. In some embodiments, a first communication chip 1112 may be dedicated to wireless communications, and a second communication chip 1112 may be dedicated to wired communications.

The computing device 1100 may include battery/power circuitry 1114. The battery/power circuitry 1114 may include one or more energy storage devices (e.g., batteries or capacitors) and/or circuitry for coupling components of the computing device 1100 to an energy source separate from the computing device 1100 (e.g., AC line power).

The computing device 1100 may include a display device 1106 (or corresponding interface circuitry, as discussed above). The display device 1106 may include any visual indicators, such as a heads-up display, a computer monitor, a projector, a touchscreen display, a liquid crystal display (LCD), a light-emitting diode display, or a flat panel display, for example.

The computing device 1100 may include a video output device 1108 (or corresponding interface circuitry, as discussed above). The video output device 1108 may include any device that generates an audible indicator, such as speakers, headsets, or earbuds, for example.

The computing device 1100 may include a video input device 1118 (or corresponding interface circuitry, as discussed above). The video input device 1118 may include any device that generates a signal representative of a sound, such as microphones, microphone arrays, or digital instruments (e.g., instruments having a musical instrument digital interface (MIDI) output).

The computing device 1100 may include a GPS device 1116 (or corresponding interface circuitry, as discussed above). The GPS device 1116 may be in communication with a satellite-based system and may receive a location of the computing device 1100, as known in the art.

The computing device 1100 may include another output device 1110 (or corresponding interface circuitry, as discussed above). Examples of the other output device 1110 may include a video codec, a video codec, a printer, a wired or wireless transmitter for providing information to other devices, or an additional storage device.

The computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1100 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1100 may be any other electronic device that processes data.

### SELECTED EXAMPLES

The following paragraphs provide various examples of the embodiments disclosed herein.

Example 1 provides a computer-implemented method, comprising: receiving a first input image from a first camera, a second input image from a second camera, and a third input image from a third camera; performing feature extraction on each of the first, second, and third images; performing feature matching between the first image and the second image, wherein the first image and the second image form a first image pair; identifying first keypoint correspondences between the first image and the second image; determining a first rotation and a first translation of the second camera with respect to the first camera based on the first keypoint correspondences; performing feature matching between the second image and the third image, wherein the second image and the third image form a second image pair; identifying second keypoint correspondences between the second image and the third image; determining a second rotation and a second translation of the third camera with respect to the second camera based on the second keypoint correspondences; determining a first translation magnitude for the first image pair; determining a translation scale for the second image pair based on the translation magnitude of the first image pair; determining a second translation magnitude for the second image pair based on the translation scale.

Example 2 provides a method, a non-transitory computer-readable media, a system, and/or an apparatus according to any of the preceding or following examples further comprising determining an essential matrix for the first image pair, and wherein determining the first rotation and the first translation includes decomposing the essential matrix to generate the first rotation and the first translation.

Example 3 provides a method, a non-transitory computer-readable media, a system, and/or an apparatus according to any of the preceding or following examples further comprising identifying triplet tracks, wherein identifying triplet tracks includes identifying common keypoints in the second image that are first keypoint correspondences and second keypoint correspondences.

Example 4 provides a method, a non-transitory computer-readable media, a system, and/or an apparatus according to any of the preceding or following examples wherein determining the first translation magnitude for the first image pair includes setting the first translation magnitude to unity.

Example 5 provides a method, a non-transitory computer-readable media, a system, and/or an apparatus according to any of the preceding or following examples wherein the translation scale is a first translation scale, and further comprising: receiving a fourth input image from a fourth camera; identifying third keypoint correspondences between the third image and the fourth image, wherein the third image and the fourth image form a third image pair; determining a third rotation and a third translation of the fourth camera with respect to the third camera based on the third keypoint correspondences; and determining a second translation scale for the third image pair based on the first translation scale.

Example 6 provides a method, a non-transitory computer-readable media, a system, and/or an apparatus according to any of the preceding or following examples further comprising determining a third translation magnitude for the third image pair based on the second translation scale.

Example 7 provides a method, a non-transitory computer-readable media, a system, and/or an apparatus according to any of the preceding or following examples wherein each of the first, second, third and fourth cameras are camera nodes, and further comprising: assigning the first camera as a source node; identifying a shortest path between the source node and each of the camera nodes, wherein the shortest path includes a plurality of edges, wherein each respective edge connects respective camera nodes of respective image pairs; and assigning one of the plurality of edges as a reference edge; wherein determining the second translation scale includes determining the second translation scale based on the reference edge.

Example 8 provides one or more non-transitory computer-readable media storing instructions executable to perform operations, the operations comprising: receiving a first input image from a first camera, a second input image from a second camera, and a third input image from a third camera; performing feature extraction on each of the first, second, and third images; performing feature matching between the first image and the second image, wherein the first image and the second image form a first image pair; identifying first keypoint correspondences between the first image and the second image; determining a first rotation and a first translation of the first camera with respect to the second camera based on the first keypoint correspondences; performing feature matching between the second image and the third image, wherein the second image and the third image form a second image pair; identifying second keypoint correspondences between the second image and the third image; determining a second rotation and a second translation of the second camera with respect to the third camera based on the second keypoint correspondences; determining a first translation magnitude for the first image pair; determining a translation scale for the second image pair based on the translation magnitude of the first image pair; determining a second translation magnitude for the second image pair based on the translation scale.

Example 9 provides a method, a non-transitory computer-readable media, a system, and/or an apparatus according to any of the preceding or following examples wherein the operations further comprise determining an essential matrix for the first image pair, and wherein determining the first rotation and the first translation includes decomposing the essential matrix to generate the first rotation and the first translation.

Example 10 provides a method, a non-transitory computer-readable media, a system, and/or an apparatus according to any of the preceding or following examples wherein the operations further comprise identifying triplet tracks, wherein identifying triplet tracks includes identifying common keypoints in the second image that are first keypoint correspondences and second keypoint correspondences.

Example 11 provides a method, a non-transitory computer-readable media, a system, and/or an apparatus according to any of the preceding or following examples wherein determining the first translation magnitude for the first image pair includes setting the first translation magnitude to unity.

Example 12 provides a method, a non-transitory computer-readable media, a system, and/or an apparatus according to any of the preceding or following examples wherein the translation scale is a first translation scale, and wherein the operations further comprise receiving a fourth input image from a fourth camera; identifying third keypoint correspondences between the third image and the fourth image, wherein the third image and the fourth image form a third image pair; determining a third rotation and a third translation of the fourth camera with respect to the third camera based on the third keypoint correspondences; and determining a second translation scale for the third image pair based on the first translation scale.

Example 13 provides a method, a non-transitory computer-readable media, a system, and/or an apparatus according to any of the preceding or following examples wherein the operations further comprise determining a third translation magnitude for the third image pair based on the second translation scale.

Example 14 provides a method, a non-transitory computer-readable media, a system, and/or an apparatus according to any of the preceding or following examples wherein each of the first, second, third and fourth cameras are camera nodes, and wherein the operations further comprise: assigning the first camera as a source node; identifying a shortest path between the source node and each of the camera nodes, wherein the shortest path includes a plurality of edges, wherein each respective edge connects respective camera nodes of respective image pairs; and assigning one of the plurality of edges as a reference edge; wherein determining the second translation scale includes determining the second translation scale based on the reference edge.

Example 15 provides an apparatus, comprising: a computer processor for executing computer program instructions; and a non-transitory computer-readable memory storing computer program instructions executable by the computer processor to perform operations comprising: receiving a first input image from a first camera, a second input image from a second camera, and a third input image from a third camera; performing feature extraction on each of the first, second, and third images; performing feature matching between the first image and the second image, wherein the first image and the second image form a first image pair; identifying first keypoint correspondences between the first image and the second image; determining a first rotation and a first translation of the first camera with respect to the second camera based on the first keypoint correspondences; performing feature matching between the second image and the third image, wherein the second image and the third image form a second image pair; identifying second keypoint correspondences between the second image and the third image; determining a second rotation and a second translation of the second camera with respect to the third camera based on the second keypoint correspondences; determining a first translation magnitude for the first image pair; determining a translation scale for the second image pair based on the translation magnitude of the first image pair; determining a second translation magnitude for the second image pair based on the translation scale.

Example 16 provides a method, a non-transitory computer-readable media, a system, and/or an apparatus according to any of the preceding or following examples wherein the operations further comprise determining an essential matrix for the first image pair, and wherein determining the first rotation and the first translation includes decomposing the essential matrix to generate the first rotation and the first translation.

Example 17 provides a method, a non-transitory computer-readable media, a system, and/or an apparatus according to any of the preceding or following examples wherein the operations further comprise identifying triplet tracks, wherein identifying triplet tracks includes identifying common keypoints in the second image that are first keypoint correspondences and second keypoint correspondences.

Example 18 provides a method, a non-transitory computer-readable media, a system, and/or an apparatus according to any of the preceding or following examples wherein determining the first translation magnitude for the first image pair includes setting the first translation magnitude to unity.

Example 19 provides a method, a non-transitory computer-readable media, a system, and/or an apparatus according to any of the preceding or following examples wherein the translation scale is a first translation scale, and wherein the operations further comprise: receiving a fourth input image from a fourth camera; identifying third keypoint correspondences between the third image and the fourth image, wherein the third image and the fourth image form a third image pair; determining a third rotation and a third translation of the fourth camera with respect to the third camera based on the third keypoint correspondences; and determining a second translation scale for the third image pair based on the first translation scale.

Example 20 provides a method, a non-transitory computer-readable media, a system, and/or an apparatus according to any of the preceding or following examples wherein the operations further comprise determining a third translation magnitude for the third image pair based on the second translation scale.

Example 21 provides a method, a non-transitory computer-readable media, a system, and/or an apparatus according to any of the preceding or following examples wherein the translation scale is a first translation scale, and further comprising: receiving a fourth input image from a fourth camera; identifying third keypoint correspondences between the third image and the fourth image, wherein the third image and the fourth image form a third image pair; determining a third rotation and a third translation of the fourth camera with respect to the third camera based on the third keypoint correspondences; and determining a second translation scale for the third image pair based on a ratio of triangulated points from the second keypoint correspondences and the third keypoint correspondences.

Example 22 provides a method, a non-transitory computer-readable media, a system, and/or an apparatus according to any of the preceding or following examples further comprising determining a third translation magnitude for the third image pair based on the first translation scale and the second translation scale.

Example 23 provides a method, a non-transitory computer-readable media, a system, and/or an apparatus according to any of the preceding or following examples wherein each of the first, second, third and fourth cameras are camera nodes, and further comprising: assigning the first camera as a source node; identifying a shortest path between the source node and each of the camera nodes, wherein the shortest path includes a plurality of edges, wherein each respective edge connects respective camera nodes of respective image pairs; and assigning one of the plurality of edges as a reference edge; wherein determining the second translation scale includes determining the second translation scale based on the reference edge.

Example 24 provides a method, a non-transitory computer-readable media, a system, and/or an apparatus according to any of the preceding or following examples, wherein the reference edge has a known translation value, wherein determining the first translation magnitude for the first image pair includes identifying an accurate first magnitude value based on the known translation value, and wherein determining the second translation magnitude for the second image pair includes identifying an accurate second magnitude value based on the known translation value.

Example 25 provides a method, a non-transitory computer-readable media, a system, and/or an apparatus according to any of the preceding or following examples implemented in a neural network.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
receiving a first input image from a first camera, a second input image from a second camera, and a third input image from a third camera;
performing feature extraction on each of the first, second, and third images;
performing feature matching between the first image and the second image, wherein the first image and the second image form a first image pair;
identifying first keypoint correspondences between the first image and the second image;
determining a first rotation and a first translation of the second camera with respect to the first camera based on the first keypoint correspondences;
performing feature matching between the second image and the third image, wherein the second image and the third image form a second image pair;
identifying second keypoint correspondences between the second image and the third image;
determining a second rotation and a second translation of the third camera with respect to the second camera based on the second keypoint correspondences;
determining a first translation magnitude for the first image pair;
determining a translation scale for the second image pair based on the translation magnitude of the first image pair;
determining a second translation magnitude for the second image pair based on the translation scale.

2. The computer-implemented method of claim 1, further comprising identifying triplet tracks, wherein identifying triplet tracks includes identifying common keypoints in the second image that are first keypoint correspondences and second keypoint correspondences.

3. The computer-implemented method of claim 1, wherein determining the translation scale for the second image pair includes determining a ratio of triangulated points from the first keypoint correspondences and the second keypoint correspondences to determine a relative translation scale between the first image pair and the second image pair.

4. The computer-implemented method of claim 1, wherein the translation scale is a first translation scale, and further comprising:
receiving a fourth input image from a fourth camera;
identifying third keypoint correspondences between the third image and the fourth image, wherein the third image and the fourth image form a third image pair;
determining a third rotation and a third translation of the fourth camera with respect to the third camera based on the third keypoint correspondences; and
determining a second translation scale for the third image pair based on a ratio of triangulated points from the second keypoint correspondences and the third keypoint correspondences.

5. The computer-implemented method of claim 4, further comprising determining a third translation magnitude for the third image pair based on the first translation scale and the second translation scale.

6. The computer-implemented method of claim 5, wherein each of the first, second, third and fourth cameras are camera nodes, and further comprising:
assigning the first camera as a source node;
identifying a shortest path between the source node and each of the camera nodes, wherein the shortest path includes a plurality of edges, wherein each respective edge connects respective camera nodes of respective image pairs; and
assigning one of the plurality of edges as a reference edge;
wherein determining the second translation scale includes determining the second translation scale based on the reference edge.

7. The computer-implemented method of claim 6, wherein the reference edge has a known translation value, wherein determining the first translation magnitude for the first image pair includes identifying an accurate first magnitude value based on the known translation value, and wherein determining the second translation magnitude for the second image pair includes identifying an accurate second magnitude value based on the known translation value.

8. One or more non-transitory computer-readable media storing instructions executable to perform operations, the operations comprising:
receiving a first input image from a first camera, a second input image from a second camera, and a third input image from a third camera;
performing feature extraction on each of the first, second, and third images;
performing feature matching between the first image and the second image, wherein the first image and the second image form a first image pair;
identifying first keypoint correspondences between the first image and the second image;
determining a first rotation and a first translation of the first camera with respect to the second camera based on the first keypoint correspondences;
performing feature matching between the second image and the third image, wherein the second image and the third image form a second image pair;
identifying second keypoint correspondences between the second image and the third image;
determining a second rotation and a second translation of the second camera with respect to the third camera based on the second keypoint correspondences;
determining a first translation magnitude for the first image pair;
determining a translation scale for the second image pair based on the translation magnitude of the first image pair;
determining a second translation magnitude for the second image pair based on the translation scale.

9. The one or more non-transitory computer-readable media of claim 8, wherein determining the translation scale for the second image pair includes determining a ratio of triangulated points from the first and second keypoint correspondences to determine a relative translation scale between the first image pair and the second image pair.

10. The one or more non-transitory computer-readable media of claim 8, wherein the operations further comprise identifying triplet tracks, wherein identifying triplet tracks includes identifying common keypoints in the second image that are first keypoint correspondences and second keypoint correspondences.

11. The one or more non-transitory computer-readable media of claim 10, wherein the operations further comprise determining a ratio of triangulated points from the common keypoints to determine the translation scale.

12. The one or more non-transitory computer-readable media of claim 8, wherein the translation scale is a first translation scale, and wherein the operations further comprise:
receiving a fourth input image from a fourth camera;
identifying third keypoint correspondences between the third image and the fourth image, wherein the third image and the fourth image form a third image pair;
determining a third rotation and a third translation of the fourth camera with respect to the third camera based on the third keypoint correspondences; and
determining a second translation scale for the third image pair based on the first translation scale.

13. The one or more non-transitory computer-readable media of claim 12, wherein the operations further comprise determining a third translation magnitude for the third image pair based on the second translation scale.

14. The one or more non-transitory computer-readable media of claim 13, wherein each of the first, second, third and fourth cameras are camera nodes, wherein the operations further comprise:
assigning the first camera as a source node;
identifying a shortest path between the source node and each of the camera nodes, wherein the shortest path includes a plurality of edges, wherein each respective edge connects respective camera nodes of respective image pairs; and
assigning one of the plurality of edges as a reference edge;
wherein determining the second translation scale includes determining the second translation scale based on the reference edge.

15. An apparatus, comprising:
a computer processor for executing computer program instructions; and
a non-transitory computer-readable memory storing computer program instructions executable by the computer processor to perform operations comprising:
receiving a first input image from a first camera, a second input image from a second camera, and a third input image from a third camera;
performing feature extraction on each of the first, second, and third images;
performing feature matching between the first image and the second image, wherein the first image and the second image form a first image pair;
identifying first keypoint correspondences between the first image and the second image;
determining a first rotation and a first translation of the first camera with respect to the second camera based on the first keypoint correspondences;
performing feature matching between the second image and the third image, wherein the second image and the third image form a second image pair;
identifying second keypoint correspondences between the second image and the third image;
determining a second rotation and a second translation of the second camera with respect to the third camera based on the second keypoint correspondences;
determining a first translation magnitude for the first image pair;
determining a translation scale for the second image pair based on the translation magnitude of the first image pair;
determining a second translation magnitude for the second image pair based on the translation scale.

16. The apparatus of claim 15, wherein determining the translation scale for the second image pair includes determining a ratio of triangulated points from the first and second keypoint correspondences to determine a relative translation scale between the first image pair and the second image pair.

17. The apparatus of claim 15, wherein the operations further comprise identifying triplet tracks, wherein identifying triplet tracks includes identifying common keypoints in the second image that are first keypoint correspondences and second keypoint correspondences.

18. The apparatus of claim 17, wherein the operations further comprise determining a ratio of triangulated points from the common keypoints to determine the translation scale.

19. The apparatus of claim 15, wherein the translation scale is a first translation scale, and wherein the operations further comprise:
receiving a fourth input image from a fourth camera;
identifying third keypoint correspondences between the third image and the fourth image, wherein the third image and the fourth image form a third image pair;
determining a third rotation and a third translation of the fourth camera with respect to the third camera based on the third keypoint correspondences; and
determining a second translation scale for the third image pair based on the first translation scale.

20. The apparatus of claim 19, wherein the operations further comprise determining a third translation magnitude for the third image pair based on the second translation scale.
